(19) United States
(12) Patent Application Publication
(10) Pub. No.: US 2025/0304812 A1
(43) Pub. Date: Oct. 2, 2025

(54) METHOD FOR PRODUCING ELECTRODE INK AND DEVICE FOR PRODUCING ELECTRODE INK

(71) Applicant: HONDA MOTOR CO., LTD., TOKYO (JP)

(72) Inventor: Koichiro SATO, WAKO-SHI (JP)

(21) Appl. No.: 19/060,706

(22) Filed: Feb. 23, 2025

(30) Foreign Application Priority Data
Mar. 27, 2024 (JP) 2024-050965

(51) Int. Cl. C09D 11/52

(52) U.S. Cl. CPC C09D 11/52

(57) ABSTRACT

A method for producing an electrode ink includes a deaerating step of removing a soluble gas that is more soluble in alcohol than nitrogen from each of first feedstock containing a conductive particle, second feedstock containing a polymer material, and a solvent containing water and a water-soluble organic solvent, and a kneading step of mixing the first feedstock from which the soluble gas has been removed, the second feedstock, and the solvent, wherein the kneading step is performed in an atmosphere of a low-solubility gas that is less soluble in alcohol than nitrogen.

### CROSS-REFERENCE TO RELATED APPLICATIONS

This application is based upon and claims the benefit of priority from Japanese Patent Application No. 2024-050965 filed on Mar. 27, 2024, the contents of which are incorporated herein by reference.

### BACKGROUND OF THE INVENTION

### Field of the Invention

The present disclosure relates to a method for producing electrode ink and a device for producing an electrode ink used for producing an electrode of an electrochemical cell.

### Description of the Related Art

Electrode ink is used in the process of manufacturing electrodes for electrochemical cells such as fuel cells and water electrolyzers. The electrode ink is a paste type coating liquid containing conductive particles such as carbon particles and is used for forming a catalyst layer and a diffusion layer by being applied to the surface of an electrolyte membrane and dried.

For example, an electrode ink for catalysts used in proton-conducting electrolyte membranes contains a carbon carrier on which a platinum catalyst is supported, an ionomer, and an appropriate solvent. The electrode ink is prepared by mixing a carbon carrier, an ionomer solution in which an ionomer is dispersed, and a solvent with each other in a kneading step (JP 2016-066510 A).

### SUMMARY OF THE INVENTION

The characteristics of the electrodes are greatly affected by the solvent of the electrode ink. As the solvent for the electrode ink, a mixture of water and an organic solvent (e.g., alcohols) that is soluble in water is used. The organic solvent has an effect of enhancing the dispersibility of polymer material such as ionomer, while reducing the adsorption rate of the polymer material (e.g., ionomer) on the conductive particles (e.g., carbon carrier). Thus, in the case of the electrode ink for catalysts, higher concentrations of the organic solvent tend to make the ionomer less prone to adhere to the carbon carrier, reduce proton transport pathways, and increase the proton resistance of the catalyst.

Similar problems occur with electrode ink used in the fabrication of gas diffusion layers. An electrode ink for a gas diffusion layer contains carbon particles as conductive particles, a water repellent agent (e.g., a fluorine-based resin) as a polymer material, and a solvent including water and an organic solvent. Increasing the proportion of water in the solvent increases the adsorbability of the polymer material on the conductive particles, the polymer material constituting the water repellent agent.

Therefore, the inventors of the present application have advanced the study of decreasing the concentration of the organic solvent contained in the solvent and increasing the proportion of water in the electrode ink in order to improve the adsorption of the polymer material on the conductive particles.

However, the inventors found that when attempting to increase the proportion of water in the solvent, there was a case where a large number of bubbles were generated in the kneading step. Furthermore, increasing the percentage of water in the solvent tends to make the mixture of electrode inks more viscous when the range of an A/W ratio is up to about 0.07, the A/W ratio being the ratio of the mass of alcohol divided by the mass of water. Therefore, once the bubbles are generated, it has been extremely difficult to remove the mixture of electrode ink (electrode paste) after that. When such an electrode ink containing the bubbles is dried, the bubbles are left as large cavities and thus the performance as an electrode is degraded. Therefore, there is a demand for a method and a device for producing an electrode ink that can suppress the generation of bubbles even when the proportion of water in the solvent of the electrode paste is increased.

The present invention aims to solve the above-mentioned problems.

A first aspect of the present disclosure is a method for producing an electrode ink including a deaerating step of removing a soluble gas that is more soluble in an organic solvent than nitrogen from each of first feedstock containing a conductive particle, second feedstock containing a polymer material, and a solvent containing water and a water-soluble organic solvent, and a kneading step of mixing the first feedstock from which the soluble gas has been removed, the second feedstock, and the solvent, wherein the kneading step is performed in an atmosphere of a low-solubility gas that is less soluble in the organic solvent than nitrogen.

A second aspect of the present disclosure is a device for producing an electrode ink including a first container that accommodates first feedstock containing conductive particles; a second container that accommodates second feedstock containing a polymer material; a third container that accommodates a water-soluble organic solvent; a fourth container that accommodates water; a low-solubility gas supply unit that supplies a low-solubility gas that is less soluble in the organic solvent than nitrogen to the first container to replace an atmosphere of the first feedstock with the low-solubility gas; a first deaerator that is connected to the second container and removes the gas from the second feedstock; a second deaerator that is connected to the third container and removes the gas from the organic solvent; a third deaerator that is connected to the fourth container and removes the gas from the water; and a stirring container that mixes, in an atmosphere of the low-solubility gas, the first feedstock whose atmosphere has been replaced with the low-solubility gas, the second feedstock from which gas has been removed, the organic solvent from which gas has been removed, and the water from which gas has been removed.

The above-described method and device for producing the electrode ink can suppress the generation of bubbles by preventing the release of soluble gas that has become insoluble from an organic solvent or the like due to mixing with water in the kneading step. As a result, the above-described method and device for producing the electrode ink can increase the proportion of water in the solvent of the electrode ink and can improve the adsorption of a polymer material to conductive particles.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram explaining steps of a method for manufacturing a unitized electrode assembly according to an embodiment;

FIG. 2 is a diagram illustrating the reaction of a solvent (normal propanol (n-propanol)) contained in a solvent in the electrode ink;

FIG. 3A is a diagram illustrating weight fractions of the electrode ink of the embodiment and the electrode ink of the comparative example and FIG. 3B is a diagram illustrating weight fractions of an ionomer solution;

FIG. 4 is a photograph of the catalyst ink with bubbles generated;

FIG. 5A is a graph showing dissolved amounts of oxygen, nitrogen, and helium in an organic solvent and FIG. 5B is a graph showing the relationship between the dissolved amount of oxygen with respect to the composition ratio of n-propanol/water (solvent) and dissolved amount of oxygen in an ionomer solution;

FIG. 6A is a diagram explaining steps of a method for producing the electrode ink according to the first embodiment and FIG. 6B is a diagram explaining a deaerating step according to the second embodiment;

FIG. 7 is a diagram illustrating a device for producing an electrode ink (catalyst ink) according to an embodiment;

FIG. 8 is a diagram illustrating a deaerator of FIG. 7; and

FIG. 9 is a diagram illustrating a stirring container of FIG. 7.

### DETAILED DESCRIPTION OF THE INVENTION

For example, electrochemical cells such as fuel cells and water electrolyzers use a unitized electrode assembly (UEA) in which an electrolyte membrane is sandwiched between a pair of electrodes. For the electrolyte membrane, for example, an ion exchange resin that is permeable to protons (cations) or hydroxide ions (anions) is used. The electrode has a catalyst layer stacked so as to cover the surface of the electrolyte membrane, and a gas diffusion layer covering the top of the catalyst layer. The catalyst layer is composed of a porous body containing a carbon carrier on which a catalyst such as platinum is supported, and an ionomer (ion exchange resin) adsorbed on the carbon carrier. The diffusion layer is composed of a porous body containing conductive particles such as carbon particles and a polymer material such as a water repellent agent.

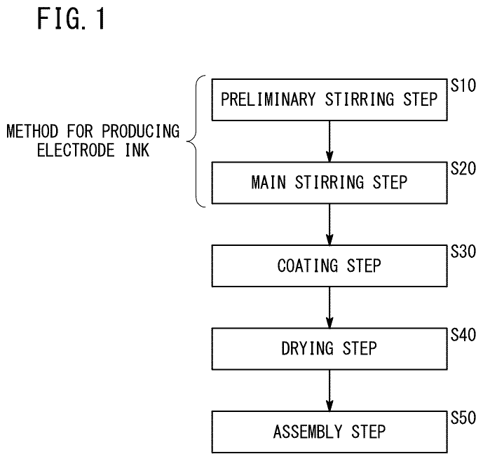

The unitized electrode assembly is manufactured through the fabricating process shown in FIG. 1. As shown in the figure, the process of manufacturing the unitized electrode assembly starts with a preliminary stirring step S10 in which the feedstock of a catalyst ink are mixed. In the preliminary stirring step S10, for example, a catalyst (conductive particles), an ionomer (ion-conducting polymer material), a first solvent, and a dispersant are mixed.

The catalyst is, for example, a carbon carrier carrying catalyst particles such as platinum, and portions of the carbon carrier constitute a path through which electric current passes. The catalyst is used as a first feedstock that is in powder form. The ionomer is used as an ionomer solution (second feedstock). The ionomer solution is a solution in which ionomers such as ion exchange resin are dissolved in an ionomer solvent containing alcohol and water. A first solvent is a mixture of alcohol such as n-propanol and water. Dispersant is added in a small amount to enhance the dispersibility of the catalyst and ionomer in the first solvent.

Then, the process of manufacturing the unitized electrode assembly proceeds to a main stirring step S20. In the stirring step S20, the feedstock of the catalyst ink are further kneaded to complete the electrode ink.

Then, the process of manufacturing the unitized electrode assembly proceeds to a coating step S30. In the coating step S30, the catalytic ink is applied to the surface of the electrolyte membrane to form a coating film of the catalytic ink.

Then, the process of manufacturing the unitized electrode assembly proceeds to a drying step S40. In the drying step S40, the first solvent is removed from the coating film of the catalytic ink and then the catalyst layer is completed. Because the formation of the catalyst layer is performed on both surfaces of the electrolyte membrane, the coating step S30 and the drying step S40 are performed on both surfaces of the electrolyte membrane, respectively.

When the gas diffusion layer is formed, the preliminary stirring step S10, the main stirring step S20, the coating step S30, and the drying step $40 are also performed on the electrode ink for the gas diffusion layer. In the case of the electrode ink for the gas diffusion layer, carbon particles are used instead of catalysts, water repellent fluorinated polymeric materials are used instead of ionomers, and a mixture of water and alcohol is used as a solvent.

Then, the process of manufacturing the unitized electrode assembly proceeds to an assembly step S50. In the assembly step S50, a unitized electrode assembly (UEA) is assembled by bonding resin frame members around the electrolyte membrane.

The characteristics of the unitized electrode assembly manufactured by the above various processes are greatly affected by the composition of the solvent of the catalyst ink. Decreasing the concentration of alcohol (e.g., n-propanol) in the solvent of the catalyst ink increases the fraction of ionomer that is adsorbed by the catalyst and contributes to an electrochemical reaction. For example, in the case of hydrogen fuel cells and electrochemical hydrogen pumps, proton-conducting ion exchange resins are used as ionomers. In this case, more ionomer is adsorbed near the catalyst, resulting in that the possible paths for protons to pass through increase and the proton resistance decreases.

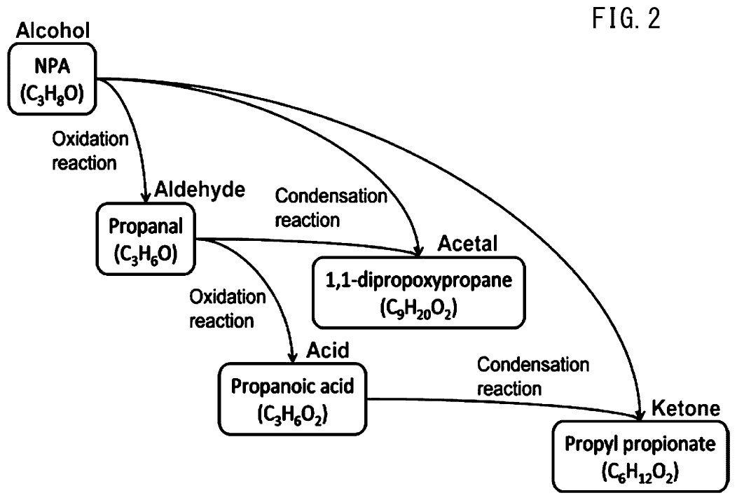

In addition, there is a possibility that alcohol contained in the solvent of the catalytic ink may contact a highly active catalyst such as platinum, thereby reacting with oxygen in the air and generating various impurities. For example, as shown in FIG. 2, normal propanol (NPA) contained in the solvent generates impurities such as propionaldehyde, dipropoxypropane, propionic acid, and propyl propionate through oxidation and condensation reactions. These impurities can cover the surface of the catalyst and reduce the catalytic activity.

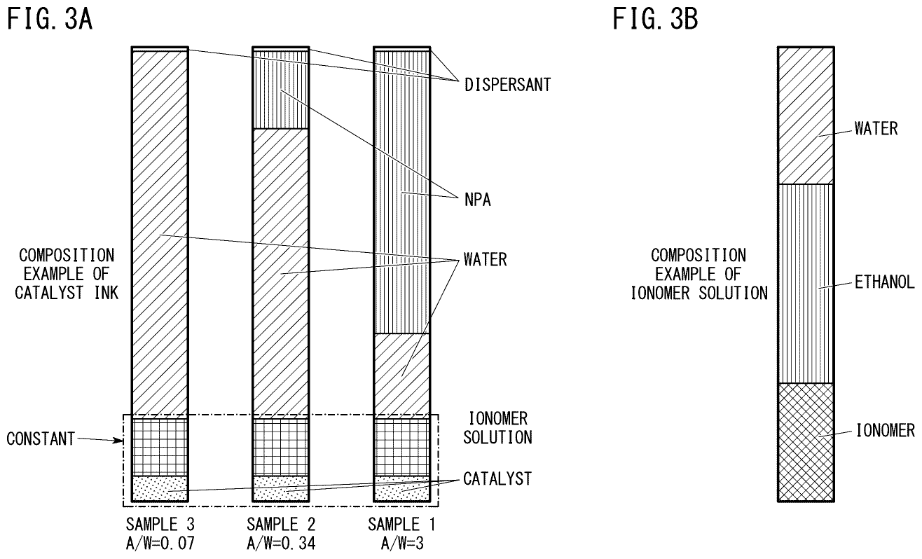

Therefore, the present inventors have attempted to prepare a catalyst ink with a lower concentration of alcohol by changing the proportion in the composition of the catalyst ink as shown in FIG. 3A. In FIG. 3A, the A/W ratio is the value obtained by dividing the weight of alcohol contained in each sample by the weight of water. The smaller the A/W ratio, the greater the proportion of water. As shown in FIG. 3B, the ionomer solution includes a predetermined amount of alcohol (e.g., ethanol) to stably dissolve the ionomer.

In Samples 1-3 of FIG. 3A, the amounts of catalyst and ionomer solution are constant, differing only in the composition of the first solvent. The percentage of water in the first solvent increases in the order of Sample 1, Sample 2, and Sample 3.

Sample 1 in FIG. 3A is a catalytic ink in which the A/W ratio of the solvent is 3. Sample 2 is a catalytic ink in which the A/W ratio of the solvent is 0.34. For Sample 3, a first solvent with water close to 100% was used. However, because Sample 1 contained alcohol derived from the ionomer solution, the A/W ratio was not 0 but 0.07.

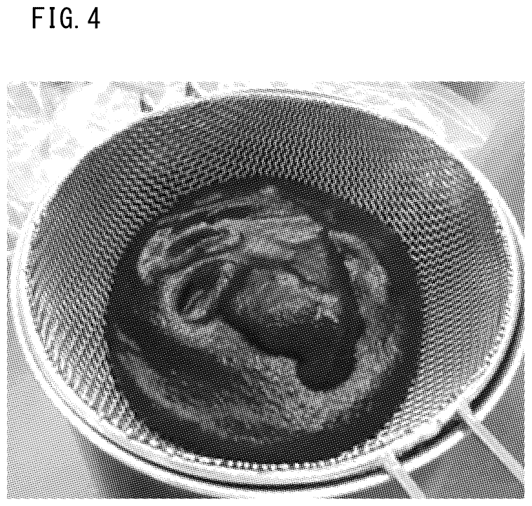

The preliminary stirring step S10 and the main stirring step S20 in FIG. 1 were performed for each of Sample 1, Sample 2, and Sample 3. For Samples 1 and 2, catalytic inks could be prepared without bubbles. On the other hand, mixing the catalyst ink of Sample 3 resulted in a large amount of bubbles as shown in FIG. 4. The catalyst ink of Sample 3 thus obtained was in the form of slurry with high viscosity and it was difficult to remove the generated bubbles later. Therefore, the catalytic ink of Sample 3 cannot be used for the formation of the catalytic layer.

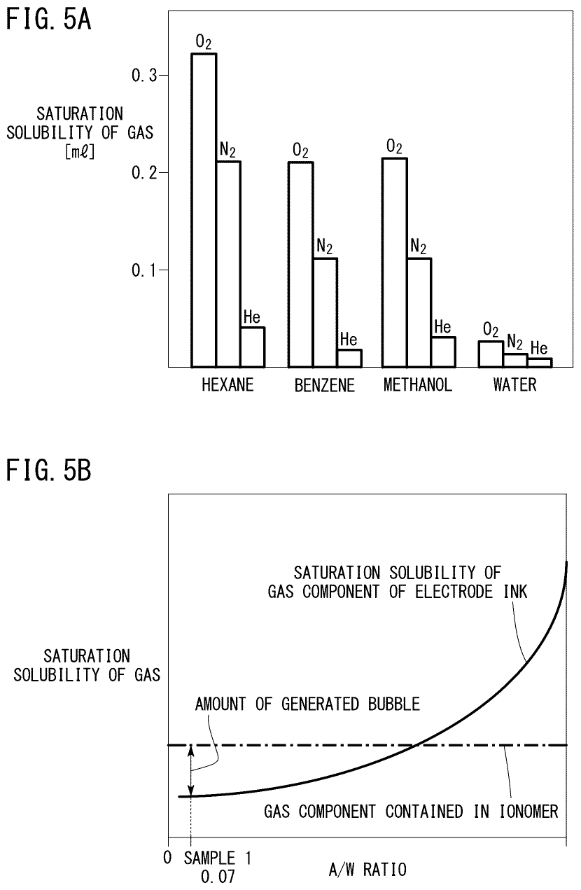

The generation of bubbles in the catalyst ink of Sample 3 is considered to be due to the influence of dissolved gases. That is, as shown in FIG. 5A, organic solvents dissolve relatively much oxygen and nitrogen. In contrast, only a small amount of oxygen and nitrogen is dissolved in water compared to organic solvents.

The bubbles of Sample 3 are considered oxygen and nitrogen that had been dissolved in the ionomer solution but were not completely dissolved and came out in the preliminary stirring step S10 to the main stirring step S20. That is, as shown in FIG. 3B, the ionomer solution contains alcohol (ethanol) as an organic solvent at a relatively high concentration and thus relatively more oxygen and nitrogen can be dissolved in the ionomer solution. When such ionomer solutions are mixed with the first solvent having a high concentration percentage of water, the alcohol concentration of the overall solvent decreases, as shown in FIG. 5B. As a result, oxygen or nitrogen contained in the ionomer solution is not completely dissolved in the electrode ink and thus bubbles are generated.

### First Embodiment

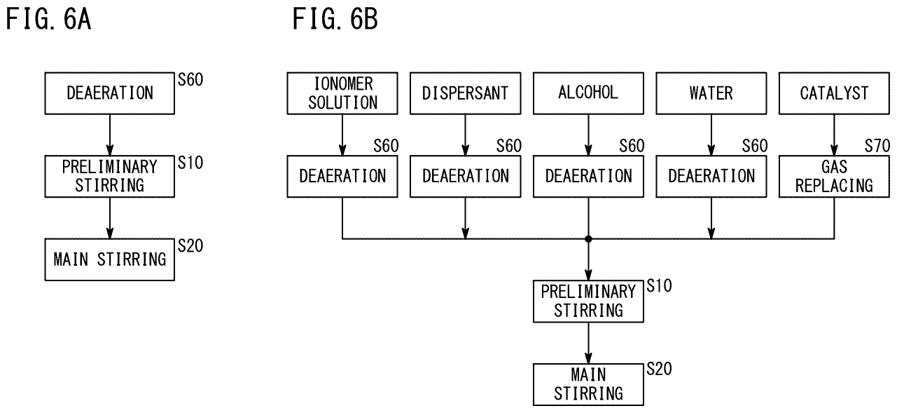

A method for producing an electrode ink according to the first embodiment includes a deaerating step S60 prior to the preliminary stirring step S10, as shown in FIG. 6A.

One aspect of the deaerating step S60 includes a step of removing gas components from at least the ionomer solution. In the deaerating step S60, for example, the ionomer solution is deaerated under reduced pressure to remove the gas components dissolved in the ionomer solution. To prevent changes in the solvent composition of the ionomer solution, deaeration under reduced pressure using a membrane separation device that can remove only gas components can be suitably used. The deaerating step S60 of this aspect lowers the amount of gas component dissolved in the ionomer solution below the saturation solubility of gas component of the electrode ink. Therefore, the method for producing the electrode ink according to this aspect can prevent the generation of bubbles in the ionomer solution when the ionomer solution is mixed with the first solvent in the preliminary stirring step S10 and the main stirring step S20.

The deaerating step S60 of the present embodiment is not limited to the deaeration under reduced pressure. The second aspect of the deaerating step S60 may be that a method in which a gas component soluble in the ionomer solution is replaced with another type of gas component whose solubility in an organic solvent such as alcohol is lower than that of nitrogen. Examples of the gas having low solubility in alcohol include helium, hydrogen, or the like. These gases have small molecular sizes and low solubility in organic solvents. Among them, helium has very low solubility in alcohol and water and can effectively prevent the generation of bubbles. Hydrogen is more soluble in alcohol than helium but less soluble in alcohol than other gases such as nitrogen. Furthermore, hydrogen can be used suitably because it is less expensive than helium. In respect of the ionomer solution substituted with helium or hydrogen in the deaerating step S60 of the present embodiment, the amount of dissolved gas decreases. Therefore, the deaerating step S60 can effectively prevent the generation of bubbles in the catalytic ink also in the subsequent steps of the preliminary stirring step S10 to the main stirring step S20.

### Second Embodiment

In a method for producing an electrode ink according to the second embodiment, a deaerating step S60 is performed on each of an ionomer solution, water and alcohol as solvents, and a dispersant. The deaerating step S60 of the present embodiment is performed by deaeration under reduced pressure or replacement with a low-solubility gas, similar to the deaerating step S60 described with reference to FIG. 6A. For a catalyst in the form of powder, the atmosphere gas is replaced with a low-solubility gas whose solubility in alcohol is lower than nitrogen in a gas replacing step S70 in FIG. 6B. The low-solubility gas is, for example, hydrogen or helium. In the preliminary stirring step S10, the catalyst and water are mixed with each other. In addition, in the preliminary stirring step S10, the ionomer solution, the alcohol, and the dispersant are separately mixed with the catalyst. Thereafter, in the main stirring step S20, water and the catalyst, and a mixture of the ionomer solution, the alcohol, and the dispersant are mixed with each other to prepare the electrode ink.

It is preferable that the preliminary stirring step S10 and the main stirring step S20 of the present embodiment are performed under an atmosphere of a low-solubility gas that has low solubility in alcohol and does not contain oxygen, not causing an oxidation reaction with alcohol even in the presence of a catalyst. For example, helium or hydrogen used in the deaerating step S60 may be used as the atmosphere gas in the preliminary stirring step S10, the main stirring step S20, and the coating step S30. By performing the preliminary stirring step S10, the main stirring step S20, and the coating step S30 under such an atmosphere of a low-solubility gas, it is possible to prevent the oxidation reaction of alcohol and suppress the generation of impurities.

In the method of producing an electrode ink of the present embodiment, the gas components with a high possibility of generating bubbles are removed from all the substances fed into the stirring step S20 through the deaerating step S60 and the gas replacing step S70. Thus, the method for producing an electrode ink of the present embodiment can more reliably reduce the generation of bubbles.

Next, a device 10 for producing an electrode ink for carrying out the deaerating step S60, the preliminary stirring step S10, the main stirring step S20, and the coating step S30 of the method for producing the unitized electrode assembly of the present embodiment will be described.

### Device for Producing Electrode Ink

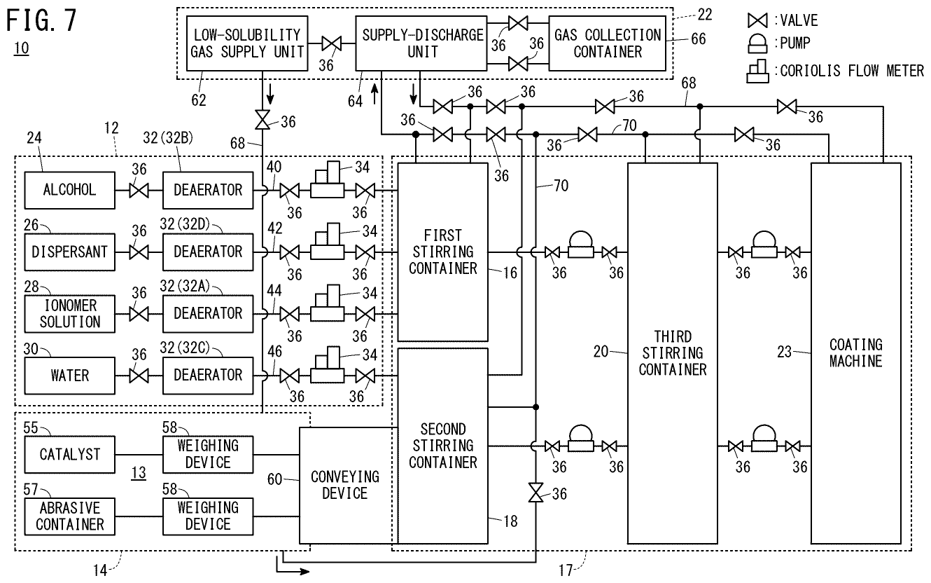

As shown in FIG. 7, the device 10 for producing an electrode ink includes a liquid feedstock preparation unit 12, a powder feedstock preparation unit 14, a first stirring container 16, a second stirring container 18, a third stirring container 20, and a low solubility gas supply unit 22. The device 10 for producing an electrode ink may include a coating machine 23 for applying the electrode ink to an electrolyte membrane, as necessary.

The liquid feedstock preparation unit 12 has an alcohol tank 24 (third container), a dispersant tank 26, an ionomer tank 28 (second container), a water tank 30 (fourth container), deaerators 32, flow meters 34, and valves 36. The alcohol tank 24 accommodates alcohol as a first component of the first solvent. The dispersant tank 26 accommodates a dispersant (liquid agent). The ionomer tank 28 accommodates an ionomer solution. The water tank 30 accommodates water as a second component of the first solvent.

The alcohol tank 24 is connected to the first stirring container 16 through a first flow field 40 while the dispersant tank 26 is connected to the first stirring container 16 through a second flow field 42. The ionomer tank 28 is connected to the first stirring container 16 through a third flow field 44. The water tank 30 is also connected to the second stirring container 18 through a fourth flow field 46. A second deaerator 32B (deaerator 32) and a flow meter 34 are connected to the first flow field 40 while a fourth deaerator 32D (deaerator 32) and a flow meter 34 are connected to the second flow field 42. A first deaerator 32A (deaerator 32) and a flow meter 34 are connected to the third flow field 44 while a third deaerator 32C (deaerator 32) and a flow meter 34 are connected to the fourth flow field 46. Each of the first flow field 40, the second flow field 42, the third flow field 44, and the fourth flow field 46 is provided with a valve 36.

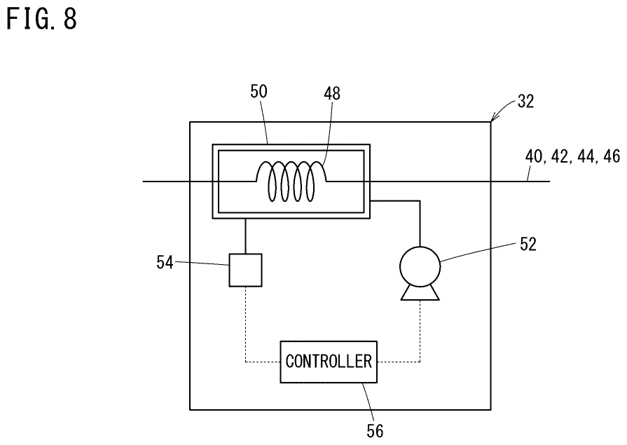

As shown in FIG. 8, the deaerator 32 is a vacuum deaeration device and includes a resin membrane tube 48, a vacuum chamber 50, a vacuum pump 52, a pressure sensor 54, and a controller 56. The resin membrane tube 48 is formed by a gas-liquid separation membrane formed of a resin having gas permeability. The resin membrane tube 48 is disposed inside the vacuum chamber 50. The resin membrane tube 48 communicates with the first flow field 40, the second flow field 42, the third flow field 44, or the fourth flow field 46 to detach the gas component from the liquid flowing through these flow fields. The deaerator 32 drives the vacuum pump 52 to maintain the vacuum chamber 50 at a negative pressure under the control of the pressure sensor 54 and the controller 56.

In FIG. 7, the flow meter 34 is, for example, a Coriolis flow meter. The flow meter 34 measures the flow rate (mass) of the liquid passing through. The valve 36 is opened and closed at a predetermined timing to supply a predetermined amount of liquid.

The powder feedstock preparation unit 14 includes a catalyst container 55 (first container), an abrasive container 57, a weighing device 58, and a conveying device 60. The catalyst container 55 accommodates a powdered catalyst such as a carbon carrier carrying platinum particles. The abrasive container 57 contains abrasive for mixing feedstock. The weighing device 58 weighs a predetermined amount of powder feedstock in a low-solubility gas atmosphere. The conveying device 60 feeds the powder feedstock into the second stirring container 18 in a low-solubility gas atmosphere. The powder feedstock preparation unit 14 is disposed in the first chamber 13 isolated from the atmosphere. The low-solubility gas supply unit 22 is connected to the first chamber 13 to which thereby low-solubility gas is supplied. The powder feedstock preparation unit 14 replaces the ambient atmosphere of the powder feedstock with a low solubility gas atmosphere.

The first stirring container 16, the second stirring container 18, the third stirring container 20, and the coating machine 23 are arranged in the second chamber 17. The second chamber 17 is isolated from the atmosphere and its interior is filled with inert gas. The interior of the second chamber 17 may be filled with a low-solubility gas supplied from the low-solubility gas supply unit 22. The first stirring container 16, the second stirring container 18, and the third stirring container 20 are connected to the low solubility gas supply unit 22 via a supply flow field 68 and a discharge flow field 70 while the inside of them is filled with a low solubility gas. The first stirring container 16 mixes alcohol, a dispersant, and an ionomer solution and supplies the resulting mixture to the third stirring container 20. The second stirring container 18 mixes water, a catalyst, and an abrasive and supplies the resulting mixed solution to the third stirring container 20.

The third stirring container 20 is used to prepare an electrode ink by kneading the catalyst, ionomer solution, dispersant, alcohol, water, and abrasive. The electrode ink prepared in the third stirring container 20 is supplied to the coating machine 23 while being maintained in a low-solubility gas atmosphere. The coating machine 23 applies the electrode ink onto the surface of the electrolyte membrane to form an electrode layer (catalyst layer). The device 10 for producing the electrode ink may have a container instead of the coating machine 23. The electrode ink produced in the third stirring container 20 may be stored in a storage container while being kept in a low-solubility gas atmosphere.

The low-solubility gas supply unit 22 includes a low-solubility gas tank 62, a supply-discharge unit 64, and a gas collection container 66. The low-solubility gas supply unit 22 is connected to the first chamber 13 and the second chamber 17 via the supply flow field 68 and the discharge flow field 70. The low-solubility gas tank 62 accommodates helium or hydrogen, for example, as a low-solubility gas. The low-solubility gas tank 62 is connected to the supply-discharge unit 64.

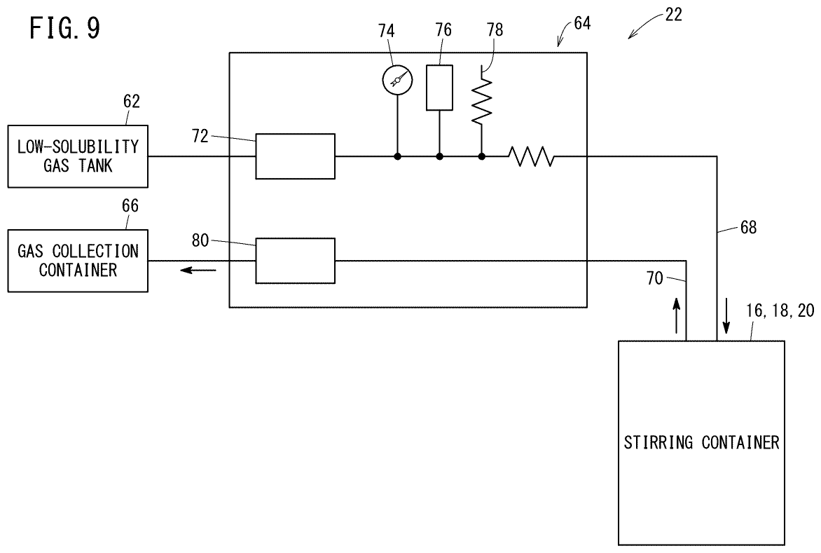

The supply-discharge unit 64 sends the low-solubility gas to the supply flow field 68 and sends the low-solubility gas in the discharge flow field 70 to the gas collection container 66. The supply-discharge unit 64 is equipped with valves to control the supply pressure. Specifically, as shown in FIG. 9, the supply-discharge unit 64 includes a pressure-reducing valve 72, a pressure gauge 74, a relief valve 76, and a resistance tube 78 in the supply flow field 68. The supply-discharge unit 64 also includes a discharge valve 80 in the discharge flow field 70. The supply-discharge unit 64 supplies the low-solubility gas at a predetermined pressure to the supply flow field 68 by the pressure-reducing valve 72, the relief valve 76, and the resistance tube 78. The supply-discharge unit 64 also discharges the low-solubility gas at a predetermined flow rate through the discharge valve 80.

The gas collection container 66 collects the gas discharged from the discharge flow field 70. The gas collection container 66 collects high-priced gas, for example, helium, to limit gas loss. When an inexpensive gas such as hydrogen is used as the low-solubility gas, the gas may go without being collected and in this case, the gas collection container 66 may be omitted from the low-solubility gas supply unit 22.

The device 10 for producing an electrode ink configured as described above can perform the method for producing an electrode ink shown in FIG. 6B.

Although the method for producing an electrode ink and the device 10 for producing an electrode ink above have been described with reference to a catalyst ink as an example, the present embodiment is not limited to this. For example, a diffusion layer ink for producing a gas diffusion layer is produced by mixing carbon powder (conductive particles), a water repellent solution (polymer material), a solvent, and a dispersant. The water repellent solution contains a water repellent resin such as a fluorine-containing polymer as a polymer material. In this case, in order to prevent the generation of bubbles, the atmosphere gas of the feedstock, carbon powder, may be replaced with a low-solubility gas having a low solubility in alcohol, and the water repellent solution and the solvent may be deaerated. This can prevent the generation of bubbles.

With respect to the above embodiments, the following supplemental notes are further disclosed.

### Supplemental Note 1

A method of the present disclosure for producing an electrode ink includes a deaerating step (S60) of removing a soluble gas that is more soluble in an organic solvent than nitrogen from each of first feedstock containing a conductive particle, second stock containing a polymer material, and a solvent containing water and a water-soluble organic solvent, and a kneading step of mixing the first feedstock from which the soluble gas has been removed, the second feedstock, and the solvent, wherein the kneading step is performed in an atmosphere of a low-solubility gas that is less soluble in the organic solvent than nitrogen.

The above-described method for producing an electrode ink can prevent the generation of bubbles in the kneading step and can increase the proportion of water in the solvent.

### Supplemental Note 2

Regarding the method for producing an electrode ink according to Supplementary note 1, at least oxygen may be removed in the deaerating step, and the low-solubility gas used in the kneading step may lack oxygen. The method for producing the electrode ink can prevent the generation of impurities caused by the reaction between an organic solvent and oxygen by means of a catalyst contained in the electrode ink and can suppress the deterioration of power generation performance caused by the impurities.

### Supplemental Note 3

Regarding the method for producing the electrode ink according to Supplementary note 1, the deaerating step may be performed by deaeration under reduced pressure. This method for producing the electrode ink can efficiently remove gaseous components from a solvent under mild conditions.

### Supplemental Note 4

Regarding the method for producing the electrode ink according to Supplementary note 3, the deaeration under reduced pressure may be performed using a gas-liquid separation membrane. This method for producing the electrode ink can suppress fluctuation in the solvent composition by preventing the solvent components from volatilizing.

### Supplemental Note 5

Regarding the method for producing the electrode ink according to Supplementary note 1, the deaerating step may be performed by replacing the soluble gas contained in the first feedstock, the second feedstock, and the solvent with the low-soluble gas. This method for producing the electrode ink can prevent the generation of bubbles in the kneading step.

### Supplemental Note 6

Regarding the method for producing an electrode ink according to Supplementary note 1, the solvent may have a value of an A/W ratio of approximately 0.07 or less, wherein the A/W ratio is acquired by dividing a mass A of the organic solvent by a mass W of the water. This method for producing the electrode ink can prevent the generation of bubbles in the kneading step even in a high water concentration range, where bubbles are significantly likely to occur.

### Supplemental Note 7

Regarding the method for producing an electrode ink according to any one of Supplementary notes 1 to 6, the first feedstock may contain a catalyst as the conductive particle, and the second feedstock may contain an ionomer containing an ion-conducting polymer as the polymer material. This method for producing the electrode ink can produce a catalyst ink that contains few bubbles.

### Supplemental Note 8

Regarding the method for producing the electrode ink according to any one of Supplementary notes 1 to 6, the first feedstock may contain a carbon particle as the conductive particles, and the second feedstock may contain a water repellent resin as the polymer material. This method for producing the electrode ink can produce a diffusion layer ink that contains few bubbles.

### Supplemental Note 9

A device (10) of the present disclosure for producing an electrode ink includes a first container (55) that accommodates first feedstock containing a conductive particle, a second container (28) that accommodates second feedstock containing a polymer material, a third container (24) that accommodates a water-soluble organic solvent, a fourth container (30) that accommodates water, a low-solubility gas supply unit (22) that supplies a low-solubility gas that is less soluble in the organic solvent than nitrogen to the first container to replace an atmosphere of the first feedstock with the low-solubility gas, a first deaerator (32A) that is connected to the second container and removes the gas from the second feedstock, a second deaerator (32B) that is connected to the third container and removes the gas from the organic solvent, a third deaerator (32C) that is connected to the fourth container and removes the gas from the water, and a stirring container (16, 18, 20) that mixes, in an atmosphere of the low-solubility gas, the first feedstock whose atmosphere has been replaced with the low-solubility gas, the second feedstock from which gas has been removed, the organic solvent from which gas has been removed, and the water from which gas has been removed.

The above-described device for producing the electrode ink can prevent the generation of bubbles in the kneading step and can increase the proportion of water in the solvent.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A method for producing an electrode ink, the method comprising:
a deaerating step of removing a soluble gas that is more soluble in an organic solvent than nitrogen from each of first feedstock containing a conductive particle, second feedstock containing a polymer material, and a solvent containing water and a water-soluble organic solvent; and
a kneading step of mixing the first feedstock from which the soluble gas has been removed, the second feedstock, and the solvent,
wherein the kneading step is performed in an atmosphere of a low-solubility gas that is less soluble in the organic solvent than nitrogen.

2. The method for producing the electrode ink according to claim 1, wherein at least oxygen is removed in the deaerating step, and the low-solubility gas used in the kneading step does not contain oxygen.

3. The method for producing the electrode ink according to claim 1, wherein the deaerating step is performed by deaeration under reduced pressure.

4. The method for producing the electrode ink according to claim 3, wherein the deaeration under reduced pressure is performed using a gas-liquid separation membrane.

5. The method for producing the electrode ink according to claim 1, wherein the deaerating step is performed by replacing the soluble gas contained in the first feedstock, the second feedstock, and the solvent with the low-solubility gas.

6. The method for producing the electrode ink according to claim 1, wherein the solvent has a value of an A/W ratio of approximately 0.07 or less, the A/W ratio being acquired by dividing a mass A of the organic solvent by a mass W of the water.

7. The method for producing the electrode ink according to claim 1, wherein
the first feedstock contains a catalyst as the conductive particle, and
the second feedstock contains an ionomer containing an ion-conducting polymer as the polymer material.

8. The method for producing the electrode ink according to claim 1, wherein
the first feedstock contains a carbon particle as the conductive particle, and
the second feedstock contains a water repellent resin as the polymer material.

9. A device for producing an electrode ink, the device comprising:
a first container that accommodates a first feedstock containing a conductive particle;
a second container that accommodates a second feedstock containing a polymer material;
a third container that accommodates a water-soluble organic solvent;
a fourth container that accommodates water;
a low-solubility gas supply unit that supplies a low-solubility gas that is less soluble in the organic solvent than nitrogen to the first container to replace an atmosphere of the first feedstock with the low-solubility gas;
a first deaerator that is connected to the second container and removes gas from the second feedstock;
a second deaerator that is connected to the third container and removes gas from the organic solvent;
a third deaerator that is connected to the fourth container and removes gas from the water; and
a stirring container that mixes, in an atmosphere of the low-solubility gas, the first feedstock whose atmosphere has been replaced with the low-solubility gas, the second feedstock from which gas has been removed, the organic solvent from which gas has been removed, and the water from which gas has been removed.
